(19) United States
(12) Patent Application Publication
(10) Pub. No.: US 2012/0212423 A1
(43) Pub. Date: Aug. 23, 2012

(54) ELECTRONIC NOTE-TAKING SYSTEM AND METHOD

(75) Inventors: MEHMET DONDURUR, DHAHRAN (SA); AHMET Z. SAHIN, DHAHRAN (SA)

(73) Assignee: KING FAHD UNIVERSITY OF PETROLEUM AND MINERALS, Dhahran (SA)

(21) Appl. No.: 13/031,570

(22) Filed: Feb. 21, 2011

(51) Int. Cl. G06F 3/041

(52) U.S. Cl. 345/173

(57) ABSTRACT

The electronic note-taking system and method includes a computer or a stand-alone handheld electronic device having note-taking software that reads, stores and displays a user's cursive writing on a digital pad or touch sensitive screen. A stylus may be included to facilitate entry into the device. A stand-alone note-taking software product or a note-taking device with embedded software is included. The stand-alone software is installable on handheld devices. Users may either purchase the software separately for their own devices or purchase the hardware with the software stored thereon. During note taking, the device secures user's notes by frequent, customizable autosaving (seconds to minutes) in a local storage device. The note-taking device is compatible with desktop/mobile computers, handheld devices, writing tablets and the like. Cursive handwriting to text conversion is optional on the device.

### BACKGROUND OF THE INVENTION

1. Field of the Invention

The present invention relates generally to devices for refreshing one's memory regarding oral presentations, and particularly to an electronic note-taking system and method.

2. Description of the Related Art

Small, touch-enabled, screen devices, such as mobile cellular telephones and personal digital assistants (“PDAs”), are increasing in popularity. A typical small, touch-enabled, screen device is a limited function microcomputer provided with a pressure-sensitive liquid crystal diode (LCD) display (a touch pad or a touch screen) for input and output (I/O). Small screen devices are useful for many purposes, including voice and wireless Internet communication, scheduling, and note taking. Often, the primary input means for these small screen devices is via the pressure-sensitive LCD display with a limited-size keypad. As these portable devices become smaller and more specialized, continuous written input has become more difficult and less practical. Pen-based user interfaces are attractive because they are scalable (i.e., only small reductions in size can be made to keyboards before they become awkward to use) and offer the pointing capabilities of a touch-screen or mouse. Furthermore, when compared to voice-based interfaces, pen-based input takes place in private, can be done in silence without disturbing bystanders, and is insensitive to acoustic noise in the environment.

Manual input on small screen devices, such as mobile cellular telephones and personal digital assistants (“PDA”), generally consists of one or more “ink traces” for user input. As is known in the art, an ink point is an element of writing in the stream of data recorded by a real-time digitizer, and a trace is a sequence of contiguous ink points. An ink trace is a complete pen-down movement hounded by two pen-up movements or a complete pen-up movement. A sequence of traces accumulates to meaningful units, such as characters and words. However, a consistent problem with existing systems is the lack of size of the touchscreen for handwriting entry by a user.

Thus, an electronic note-taking system and method solving the aforementioned problems is desired.

### SUMMARY OF THE INVENTION

The electronic note-taking system and method includes a computer or a stand-alone handheld electronic device having note-taking software that reads, stores and displays a user's cursive writing on a digital pad or touch sensitive screen. A stylus is included to facilitate entry into the device. A stand-alone note-taking software product or a note-taking device with embedded software is included. The stand-alone software is installable on handheld devices. Users may either purchase the software separately for their own devices, or purchase the hardware with the software stored thereon.

During note taking, the device secures the user's notes by frequent, customizable autosaving (seconds to minutes) in a local storage means. The note-taking device is compatible with desktop/mobile computers, handheld devices, writing tablets and the like. Cursive handwriting to text conversion is optional on the device.

These and other features of the present invention will become readily apparent upon further review of the following specification and drawings.

### BRIEF DESCRIPTION OF THE DRAWINGS

FIG. 1 is a front view of an exemplary electronic note-taking device showing a screenshot typical of a user interface in an electronic note-taking system according to the present invention.

FIG. 2 is a front view of the electronic note taker of FIG. 1, showing a screenshot without grid-lines.

FIG. 3 is a front view of the electronic note taker of FIG. 1, showing a screenshot in portrait mode.

FIG. 4 is a detailed view of an exemplary toolbar for the electronic note taker interface of FIG. 1.

FIG. 5 is a top plan view of the electronic note taker of FIG. 1, shown with the lid open.

FIG. 6 is a top plan view of the electronic note taker of FIG. 5, shown with the touchscreen exposed and the lid folded back.

FIG. 7 is a top plan view of the electronic note of FIG. 5, taker with the touchscreen covered by the lid.

FIG. 8 is a side view of the electronic note taker of FIG. 5, shown with the lid folded back.

FIG. 9 is a side view of the electronic note taker of FIG. 5, shown with the lid covering the touchscreen.

Similar reference characters denote corresponding features consistently throughout the attached drawings.

### DETAILED DESCRIPTION OF THE PREFERRED EMBODIMENTS

As shown in FIGS. 1-3, the electronic note-taking system and method 100 includes a computer or a stand-alone handheld electronic device having note-taking software that reads, stores and displays a user's cursive writing on a digital pad or touch sensitive screen. A stylus may be included to facilitate entry into the device 100. A stand-alone note-taking software product or a note-taking device with embedded software is included. The stand-alone software product is installable on handheld devices and comprises a medium readable by a processor, the medium having stored thereon a set of instructions that will implement the electronic note-taking methods described herein. Users may either purchase the software separately for their own devices, or purchase the hardware with the software stored thereon.

During note taking, the device secures user's notes by frequent, customizable autosaving (seconds to minutes) in a local storage means. The note-taking device 100 is compatible with desktop/mobile computers, handheld devices, writing tablets and the like. Cursive handwriting to text conversion is optional on the device.

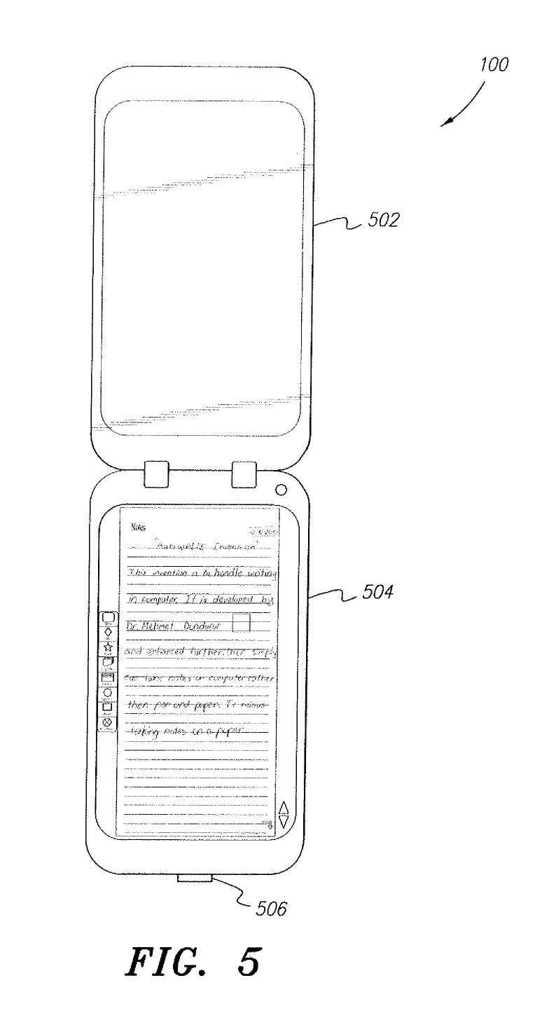

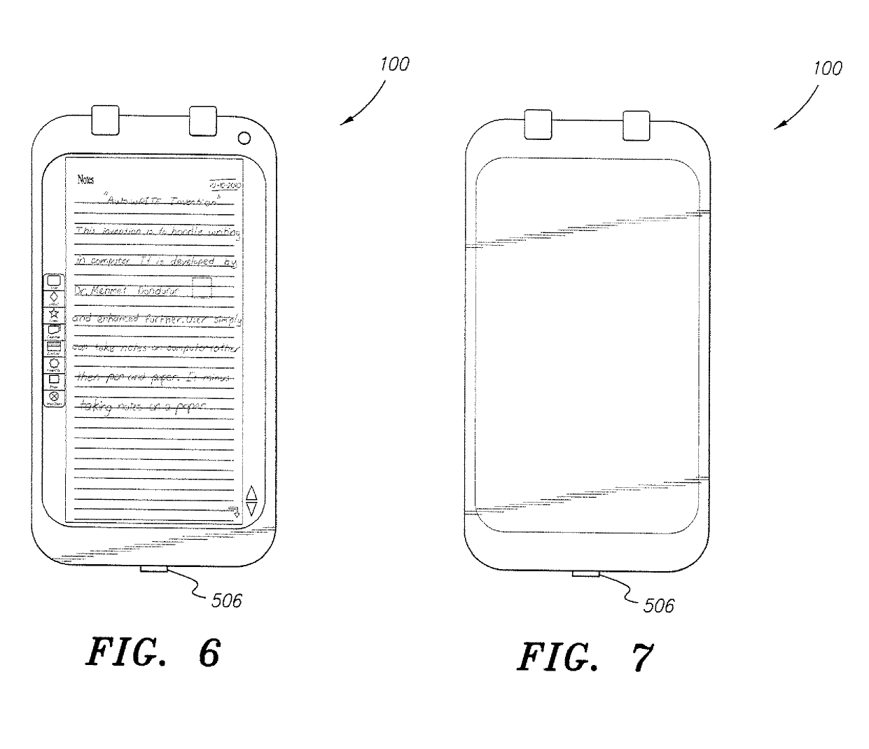

The device 100 allows basic functions, such as scroll up and down, open/close, printing, saving, email, deleting, etc. The note-taking apparatus 100 secures user's notes via local or external drives. It allows the user to save notes in either of those locations, with a third option being an e-mail account. The system will be quick-saving, efficient and portable for any note takers. The hardware device will come in a few different sizes with, as shown in FIG. 5, a fold-back lid 502, a lid-locking mechanism 506, and a base 504. The apparatus 100 is functional with all major platforms, saves time and money, and will be environmentally friendly. The lid 502 has a gradual arcuate taper extending from back to front of the unit 100 that covers a corresponding gradual arcuate taper of the base 504. The device 100 has human factors design that is compatible with student or industry use. Students will be able to use the apparatus's capabilities via handheld or larger, tablet-sized computers.

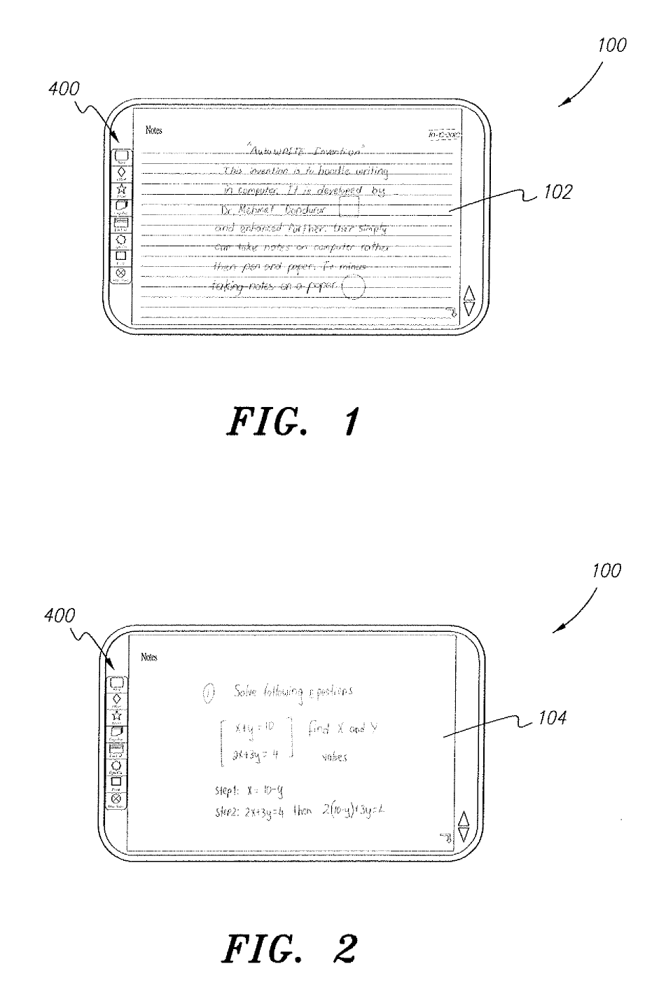

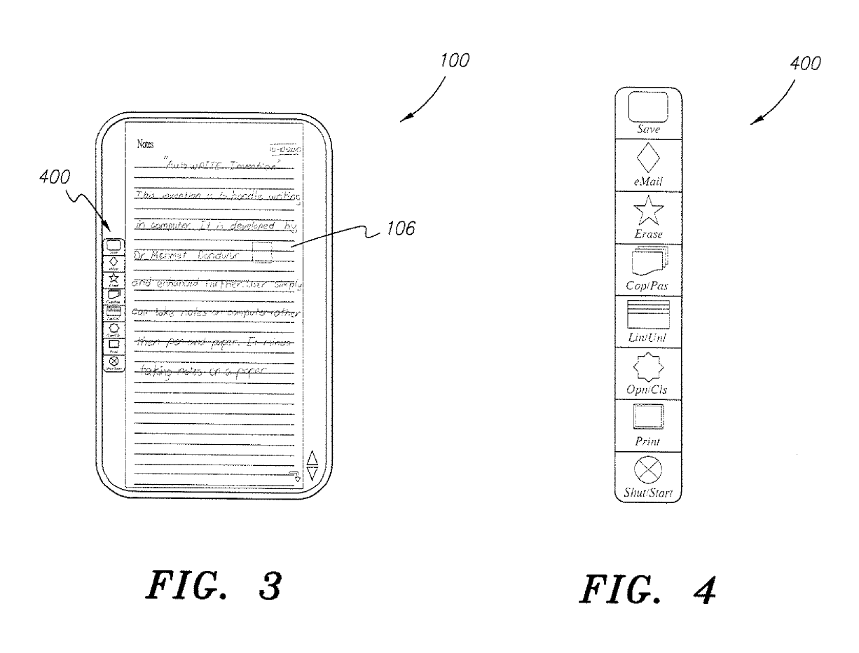

As shown in FIG. 1, the screen can display in a ruled line landscape mode 102. As shown in FIG. 2, the screen can display in landscape mode 104 without ruled lines. As shown in FIG. 3, the device can also display the electronic ink in a portrait mode 106. As shown in FIGS. 1-3, a toolbar 400 having a plurality of icons is presented on the left hand side of the device 100. A scrolling icon is presented on the right hand side of the screen portion of the base 504.

FIG. 4 shows the vertically aligned toolbar 400 in more detail. The “Save” icon is touched to save a current document manually, and also simultaneously in two storage locations: an internal hard drive and an external pen drive. The apparatus 100 will provide an option to save notes automatically (customizable periodic autosave—seconds and/or minutes) while the user takes notes. Besides autosave, the “Save” icon is provided for manual saving, if the user wishes to click on the icon to save it. The apparatus 100 will allow the user to use both autosave and manual save options during the writing.

A touch of the “Erase” icon causes the processor to erase or delete the whole line or partial note. A touch of the “Print” icon causes the device 100 to print the displayed notes. A touch of the “E-mail” icon causes the device 100 to send a current and/or a saved document to an e-mail account if the Internet connection is enabled. A touch of the “Scroll” button causes the screen contents to scroll up and down the page according to the up arrow or the down arrow being activated. A touch of the Shut/Start icon causes the device 100 to shut down or restart accordingly. When the user clicks the “Shut/Start” button, the device 100 will present “Shut down” and “Restart” sub-icons to choose from.

Similar to a Return or Enter key on a keyboard, a touch of the “Return” icon causes the entry cursor to go to a next/new line or paragraph before the line ends. Software goes to the next line when the user reaches the end of the line. However, a return is needed when the user wishes to go to the next line before the end of the line. The “Return” icon will always be positioned at the end of the line for best convenience. The “Return” icon is visible all of the time and follows the last line on the farthest right portion of the writing window.

A touch of the “Open/Close” icon causes the processor of the device 100 to open/close a designated note-taking file.

A touch of the “Lin/Unl” icon causes switching between lined and unlined note-taking formats. The default setting is the lined or ruled option. A touch of the “Cop/Pas” icon causes the machine 100 to Copy and Paste within the note-taking window. A touch of the “Keyboard” icon causes the processor 100 to present a Virtual keyboard, which can be used for e-mail composition and note taking. The user will be able to switch to a virtual keyboard by touching the “Keyboard” icon on the screen. Using the virtual keyboard function facilitates sending email and adding electronic text to the digital ink note taking.

To operate the note-taking system 100 in a desktop or a mobile device, the user launches the system software, opens a new or existing file, and then starts writing or taking notes using his/her finger, or using a stylus with a desktop or mobile computer. When the user starts writing on a screen or writing pad, or computer, the software of the system 100 accepts whatever is written by finger or stylus on screen and saves it very quickly (there is a custom periodic save) in such possible locations as a local hard drive, a secondary internal or external drive, a USB drive, and E-mail or on the Web.

After completion of the note taking, the software of system 100 will save notes automatically using the autosave feature, or the user can manually save the notes.

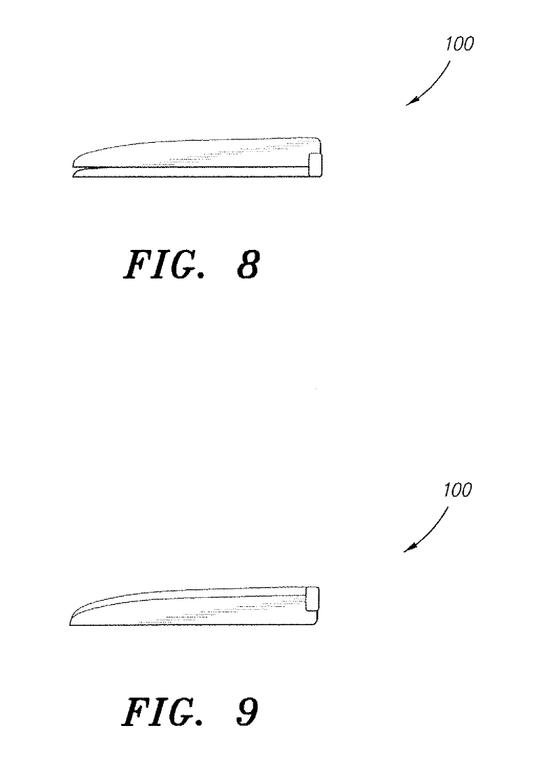

The device 100 is a mobile device having rounded corners. The device 100 is approximately ½ inch thick with a ten-inch wide screen. The device 100 has no keyboard. The lid 502 (shown in FIG. 5) is approximately ¼ inch in thickness and is pivotally attached to the base 504 so that it can cover the screen of the base (as shown in FIGS. 7-9). The foremost end of the device facing the user is thinner than other parts of the body to accommodate the user's hands during note taking.

Component parts of the system 100 may include software, a stylus, three-cell Li-Ion rechargeable batteries, two internal and external storages, a hard drive, and the like. The stylus functions like a pen/pencil. Therefore, a mouse and keyboard will not be required to perform note taking on the system 100. The note-taking apparatus 100 may be provided in exemplary dimensions, e.g., ¼ inch thickness, 4 by 2½ (L×W) inch screen and writing base, or ¼ inch thickness, 5 by 3 (L×W) inch screen and writing base, or ¼ inch thickness, 10 by 7 (L×W) inch window screen and writing base. Body sizes will be ½ inch larger than dimensions above.

If the user is using a desktop or other such computer that does not have touch screen capability, the screen will display what the user is writing on both the desktop computer screen and the digital writing pad of base 504. The user will be able to use the device approximately 4-5 hours without any external power and will be able to recharge with an adaptor or use the device with an adaptor that is plugged to the electric outlet. The device 100 will provide ports for USB for external devices, Internet connection, and an AC power adaptor.

To operate the device 100, the user will open the lid by pressing the lock/release button 506 located in front of the device 100. There may be a slight spring bias in the lid that allows the lid 502 to be released and pop up a small amount, thus enabling the user to manually lift the lid 502 upward completely. Then the user will power the device via a power button located on device 100. Subsequently, the note-taking screen portion of the base 504 automatically activates by requesting a new note-taking file or an existing file to process. The user can then start writing notes with a finger or stylus and save written notes either by periodic autosaving options or manual saving options during the note taking. The user has complete control of the functionalities of the device 100 by touching appropriate toolbar icons 400 on the screen. When the user is finished writing notes, the user will be able to save the notes automatically or manually. The system 100 then closes the active file via the “Close/Open” icon under the toolbar 400. A power button push or closing the lid powers off the system 100.

It is to be understood that the present invention is not limited to the embodiments described above, but encompasses any and all embodiments within the scope of the following claims.

We claim:

1. An electronic note-taking system, comprising:
a housing including a base and a lid, the lid being pivotally attached to the base;
a touchscreen disposed in the base, the lid being selectively pivotal to protectively shield the touchscreen in a locked closed position and to expose the touchscreen in an unlocked open position;
an internal computer memory disposed in the housing;
means for displaying pixels on the touchscreen corresponding to user touches, the touched pixels being displayed in a manner visibly distinguishable from untouched screen regions in order to display in digital ink a handwritten entry by the user;
means for automatically storing the digital ink handwriting in the internal computer memory for later retrieval and display on the touchscreen;
means for automatically storing the digital ink handwriting in an external computer memory; and
means for automatically sending the digital ink handwriting to a user-specified e-mail account.

2. The electronic note-taking system according to claim 1, further comprising:
means for displaying a toolbar arranged in a single column on an extreme left-hand side of said touchscreen display, the toolbar having a plurality of icons corresponding to user-selectable menu options; and
means for displaying a scroll bar arranged at a lower right-hand side of said touchscreen display.

3. The electronic note-taking system according to claim 2, wherein said toolbar icons include:
a first icon corresponding to an option for manually saving the digital ink handwriting;
a second icon corresponding to an option for erasing or deleting a whole line or partial line of the digital ink handwriting;
a third icon corresponding to an option for copying and pasting within the note-taking window;
a fourth icon corresponding to an option for sending current and saved documents to an e-mail account;
a fifth icon corresponding to an option for switching between ruled and unruled note-taking formats;
a sixth icon corresponding to an option for printing the notes;
a seventh icon corresponding to an option for opening and closing a note-taking file;
an eighth icon corresponding to an option for shut down or restart the note-taking system; and
a ninth icon corresponding to an option for launching a virtual keyboard.

4. The electronic note-taking system according to claim 3, further comprising a USB port disposed in said housing, the USB port being adapted for selectively connecting said system to an external memory device and an external computer.

5. The electronic note-taking system according to claim 4, further comprising means for displaying the handwritten entry both on said touchscreen and on a display device of the external computer.

6. The electronic note-taking system according to claim 4, further comprising means for selectively displaying the handwritten entry in portrait mode and selectively displaying the handwritten entry in landscape mode on said touchscreen.

7. An electronic note-taking method implemented on an electronic device having a touchscreen and internal memory, comprising the steps of:
displaying pixels of the touchscreen corresponding to user touches, the touched pixels being displayed in a manner visibly distinguishable from display of untouched screen regions in order to display in digital ink a handwritten entry by the user;
automatically storing the digital ink handwriting in the internal memory for later retrieval and display on the touchscreen;
automatically storing the digital ink handwriting in an external computer memory; and
automatically sending the digital ink handwriting to a user-specified e-mail account.

8. The electronic note-taking method according to claim 7, further comprising the steps of:
displaying a toolbar arranged in a single column on an extreme left-hand side of said touchscreen display, the toolbar having a plurality of icons corresponding to user-selectable menu options; and
displaying a scroll bar arranged at a lower right-hand side of said touchscreen display.

9. The electronic note-taking method according to claim 8, further comprising the steps of:
saving said digital ink handwriting in response to touching a first icon in said toolbar;
erasing or deleting a whole line or partial line of said digital ink handwriting in response to touching a second icon in said toolbar;
copying and pasting within the note-taking window in response to touching a third icon in said toolbar;
sending current and saved documents to an e-mail account in response to touching a fourth icon in said toolbar;
switching between lined and unlined note-taking formats in response to touching a fifth icon in said toolbar;
printing the notes in response to touching a sixth icon in said toolbar;
opening and closing a note-taking file in response to touching a seventh icon in said toolbar;
shut down or restart of said note-taking system in response to touching an eighth icon in said toolbar; and
launching a virtual keyboard in response to touching a ninth icon in said toolbar.

10. The electronic note-taking method according to claim 8, further comprising the step of selectively displaying the handwritten entry in portrait mode and selectively displaying the handwritten entry in landscape mode on said touchscreen.

11. A computer software product, comprising a medium readable by a processor, the medium having stored thereon a set of instructions for electronic note taking, the set of instructions including:
(a) a first sequence of instructions which, when executed by the processor, causes the processor to display pixels of a touchscreen corresponding to user touches, the touched pixels being displayed in a manner visibly distinguishable from display of untouched screen regions in order to display in digital ink a handwritten entry by the user;
(b) a second sequence of instructions which, when executed by the processor, causes said processor to automatically store the digital ink handwriting in an internal computer memory associated with said processor for later retrieval and display on the touchscreen;
(c) a third sequence of instructions which, when executed by the processor, causes said processor to automatically store the digital ink handwriting in an external computer memory;
(d) a fourth sequence of instructions which, when executed by the processor, causes said processor to automatically send the digital ink handwriting to a user-specified e-mail account.

12. The computer software product according to claim 11, further comprising:
(e) a fifth sequence of instructions which, when executed by the processor, causes said processor to display a toolbar arranged in a single column on an extreme left-hand side of said touchscreen display, said toolbar having a plurality of icons corresponding to user-selectable menu options; and
(f) a sixth sequence of instructions which, when executed by the processor, causes said processor to display a scroll bar arranged at a lower right-hand side of said touchscreen display.

13. The computer software product according to claim 12, further comprising:
(g) a seventh sequence of instructions which, when executed by the processor, causes said processor to save said digital ink handwriting in response to touching a first icon in said toolbar;
(h) an eighth sequence of instructions which, when executed by the processor, causes said processor to erase or delete a whole line or partial line of said digital ink handwriting in response to touching a second icon in said toolbar;
(i) a ninth sequence of instructions which, when executed by the processor, causes said processor to copy and paste within the note-taking window in response to touching a third icon in said toolbar;
(j) a tenth sequence of instructions which, when executed by the processor, causes said processor to send current and saved documents to an e-mail account in response to touching a fourth icon in said toolbar;
(k) an eleventh sequence of instructions which, when executed by the processor, causes said processor to switch between lined and unlined note-taking formats in response to touching a fifth icon in said toolbar;
(l) a twelfth sequence of instructions which, when executed by the processor, causes said processor to print said notes in response to touching a sixth icon in said toolbar;
(m) a thirteenth sequence of instructions which, when executed by the processor, causes said processor to open and close a note-taking file in response to touching a seventh icon in said toolbar;
(n) a fourteenth sequence of instructions which, when executed by the processor, causes said processor to shut down or restart said note-taking system in response to touching an eighth icon in said toolbar; and
(o) a fifteenth sequence of instructions which, when executed by the processor, causes said processor to launch a virtual keyboard in response to touching a ninth icon in said toolbar.

14. The computer software product according to claim 12, further comprising a seventeenth sequence of instructions which, when executed by the processor, causes said processor to selectively display the handwritten entry in portrait mode and to selectively display the handwritten entry in landscape mode on said touchscreen.
